(19) United States
(12) Patent Application Publication
(10) Pub. No.: US 2005/0091304 A1
(43) Pub. Date: Apr. 28, 2005

(54) Telecommunications device and method

(75) Inventor: Dan L. Trayler, Mint Hill, NC (US)

Correspondence Address: Adams Evans P.A.;2180 Two Wachovia Center, 301 S. Tryon Street, Charlotte, NC, 28282, US

(73) Assignee: Advanced Premise Technologies, LLC, Charlotte, NC (US)

(21) Appl. No.: 10/974,424

(22) Filed: Oct. 27, 2004

Related U.S. Application Data
(60) Provisional application No. 60/514,657, filed on Oct. 27, 2003.

(51) Int. Cl. G06F 15/16

(52) U.S. Cl. 709/200

(57) ABSTRACT

A control system for a telecommunications portal includes a modular chassis including an Ethernet backplane and a platform management bus which houses at least one application module, at least one functional module, and a portal executive. The modules are connected to the backplane and the management bus. At least one sensor detects operational parameters of at least one of the modules and transmits sensor data representative of the operational parameters over the management bus. The portal executive includes receives the sensor data from the management bus, compares the sensor data to pre-established baseline values for the operational parameters, and performs a control action in response to a deviation of the sensor data from the baseline values.

### CROSS-REFERENCE TO RELATED APPLICATIONS

This application claims the benefit of U.S. Provisional Application No. 60/514,657, filed Oct. 27, 2003.

### BACKGROUND OF THE INVENTION

This invention relates generally to telecommunications technology and more particularly to an integrated electronic telecommunications device and system. Many systems are available which depend on electronic information exchange. Examples include the Internet, local area networks (LAN), wide area networks (WAN), broadcast video, broadcast audio, close-d-circuit television, video on demand, voice over Internet protocol (VoIP) and videoconferencing, among many others. These information exchange systems require some means of physical distribution, such as cabling, optical fibers, or wireless transmission must be used to transfer and route the information. Furthermore, some of these systems required a central server or office which transfers information to a remote client or customer location. Typically, each individual information exchange system has its own architecture and hardware requirements. For example, a LAN connected to the internet connection requires a workstation, possibly a proxy server computer, and a router or switch to distribute information to an in-building network. If, for example, a videoconferencing system is provided at the same physical location, it requires a video camera, microphone, TV monitor, distribution hardware and wiring. This situation results in the use of redundant and expensive hardware systems which are difficult to upgrade.

Systems have been provided which attempt to combine multiple units performing these functions in a single unit or “hub”. However, these hubs have many components which are subject to degradation and failure. Prior art hubs can fail or go “off-line” without warning. Although the capability exists to determine if a unit has failed, this information is only provided after the fact. Thus results in system downtime, which may be unacceptable in certain circumstances, for example financial or medical systems.

### SUMMARY OF THE INVENTION

Accordingly, it is an object of the present invention to provide an integrated telecommunications system which supplies multiple information exchange requirements.

It is another object of the invention to provide a telecommunications portal which is modular and easily upgradeable.

It is another object of the invention to provide a telecommunications portal which is able to proactively-monitor-the health of its components.

These and other objects of the present invention are achieved in one embodiment of the invention by providing control system for a telecommunications portal which includes a modular chassis including an Ethernet backplane and a platform management bus. At least one application module is mounted in the chassis and connected to the backplane and the management bus. The application module performs at least one audio, visual, or data function and transmits or receives data related to the function over the backplane. At least one functional module is mounted in the chassis which supports the operation of the application module. At least one sensor is operable to detect operational parameters of at least one of the modules and transmit sensor data representative of the operational parameters over the management bus, and a portal executive is connected to the backplane and the management bus. The portal executive includes means for receiving the sensor data from the management bus, comparing the sensor data to pre-established baseline values for the operational parameters, and performing a control action in response to a deviation of the sensor data from the baseline values.

According to another embodiment of the invention, the control action is chosen from the group consisting of: sending an alarm message to a predetermined email address, sending an alert signal to a preselected pager, generating an audible alarm, generating a visual alarm, shutting down an affected module, resetting an affected module, powering-up a backup module, and combinations thereof.

According to another embodiment of the invention, the portal executive is operable to selectively power-up or power-down the module.

According to another embodiment of the invention, the portal executive is operable to selectively reset the module.

According to another embodiment of the invention, the sensor data is categorized into at least two categories depending upon the degree of deviation of the sensor data from the baseline values, and the control action is selected based upon which category the sensor data falls into.

According to another embodiment of the invention, the sensor data is characterized into at least minor, major, critical, and non-functional categories, each of the categories representing progressively greater deviation from the baseline values.

According to another embodiment of the invention, the module includes a cooling fan driven by an electric motor, and a sensor for detecting the speed of the motor.

According to another embodiment of the invention, the application module includes a plurality of operational components mounted on a circuit board, and the application module includes a sensor which detects the temperature of the circuit board.

According to another embodiment of the invention, the application module includes a plurality of operational components mounted on a circuit board, and the application module includes a sensor which detects the current flow through the circuit board.

According to another embodiment of the invention, the chassis includes a plurality of slots for receiving modules, and the slots are continuously polled by the portal executive to determine at least one of: the presence of a module in a specific slot of the chassis; the specific model of each module present; and a unique identification of each module.

According to another embodiment of the invention, the portal includes means for updating a software program of at least one of the modules.

According to another embodiment of the invention, a method for controlling a telecommunications portal includes: providing a modular chassis including an Ethernet backplane and a platform management bus; providing a portaL executive which is connected to the backplane and the management bus; providing at least one application module operable to perform at least one audio, visual, or data function, which is mounted in the chassis and connected to the backplane and the management bus; providing at least one functional module mounted in the chassis which supports the operation of the application module; Operational parameters of at least one of the modules are detected and sensor data corresponding to the operational parameters is transmitted through the management bus. Predetermined baseline values are established for the operational parameters. The sensor data is received and compared to the baseline values. A control action is performed whenever the sensor data deviates from the baseline values.

### BRIEF DESCRIPTION OF THE DRAWINGS

The subject matter that is regarded as the invention may be best understood by reference to the following description taken in conjunction with the accompanying drawing figures in which:

FIG. 1 is a schematic view of a telecommunications system constructed in accordance with the present invention;

FIG. 2 is a schematic view of a network central office server connected to a remote client network;

FIG. 3 is a schematic view of a remote client network constructed in accordance with the present invention;

FIG. 4 is a schematic perspective front view of a hardware chassis for use with the present invention;

FIG. 5 is a schematic perspective rear view of the chassis of FIG. 4;

FIG. 6 is a schematic view of the functional arrangement of a telecommunications portal constructed in accordance with the present invention.

FIG. 7 is a block diagram depicting the information flow in the configuration software of a control module constructed according to the present invention;

FIG. 8 is a block diagram depicting the configuration of system settings in the configuration software;

FIG. 9 is a block diagram depicting the server configuration in the configuration software;

FIG. 10 is a block diagram depicting the data flow configuration in the configuration software;

FIG. 11 is a block diagram depicting layer 2 data configuration in the configuration software;

FIG. 12 is a block diagram depicting layer 3 data configuration in the configuration software;

FIG. 13 is another block diagram depicting layer 3 data configuration in the configuration software;

FIG. 14 is another block diagram depicting layer 3 data configuration in the configuration software;

FIG. 15 is a block diagram depicting class-of-service configuration in the configuration software;

FIG. 16 is a block diagram depicting high availability configuration in the configuration software;

FIG. 17 is a block diagram depicting wide area network configuration in the configuration software;

FIG. 18 is a block diagram depicting wireless device configuration in the configuration software;

FIG. 19 is a block diagram depicting software configuration of a voice-over-internet-protocol module; and

FIG. 20 is a block diagram depicting software configuration of a video module.

### DETAILED DESCRIPTION OF THE INVENTION

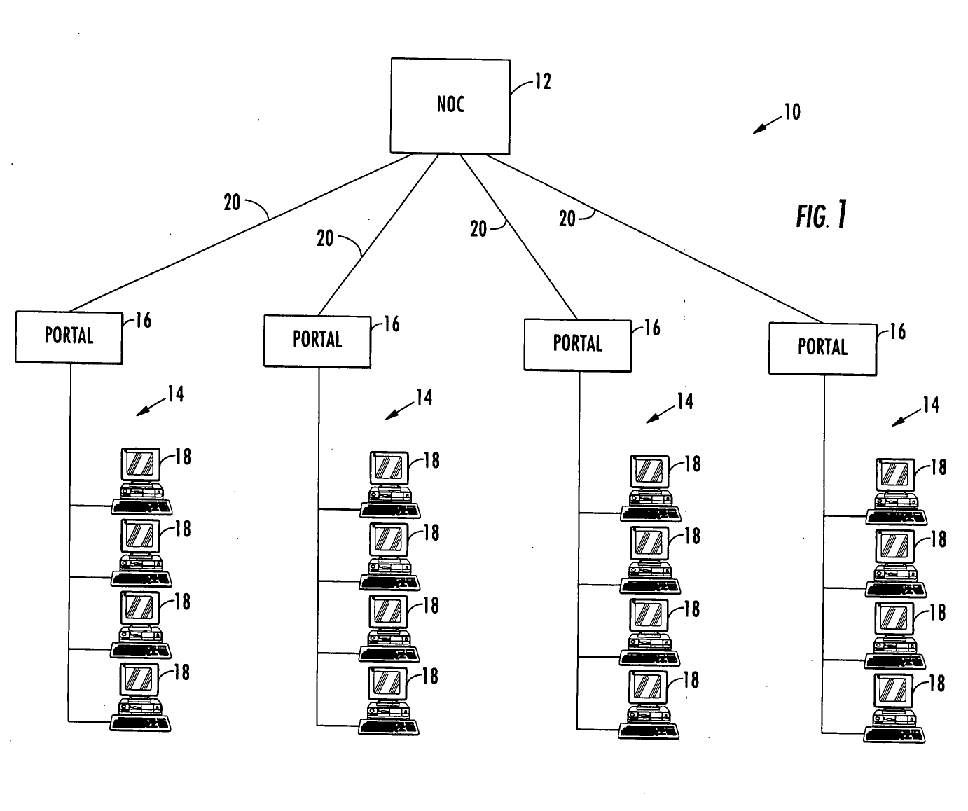

Referring to the drawings wherein identical reference numerals denote the same elements throughout the various views, FIG. 1 shows a schematic view of an exemplary telecommunications system 10 constructed in accordance with the present invention. The telecommunications system 10 includes a network operating center (NOC) 12 located at a central office or server location, and one or more remote client networks (RCN) 14 located at remote facilities. Each remote client network 14 comprises a portal 16, described in more detail below, and one or more end user units 18. The network operating center 12 is connected to the remote client networks 14 by a packet switched network over data lines 20. A variety of known network standards may be used to transmit packets over the data lines, for example optical (860 nm, 1310 nm, 1550 nm, 1550 CWDM, 1550 DWDM), or 10/100/1000 BaseT Ethernet. In the illustrated example the data lines 20 are 128 Kbps T-1 lines.

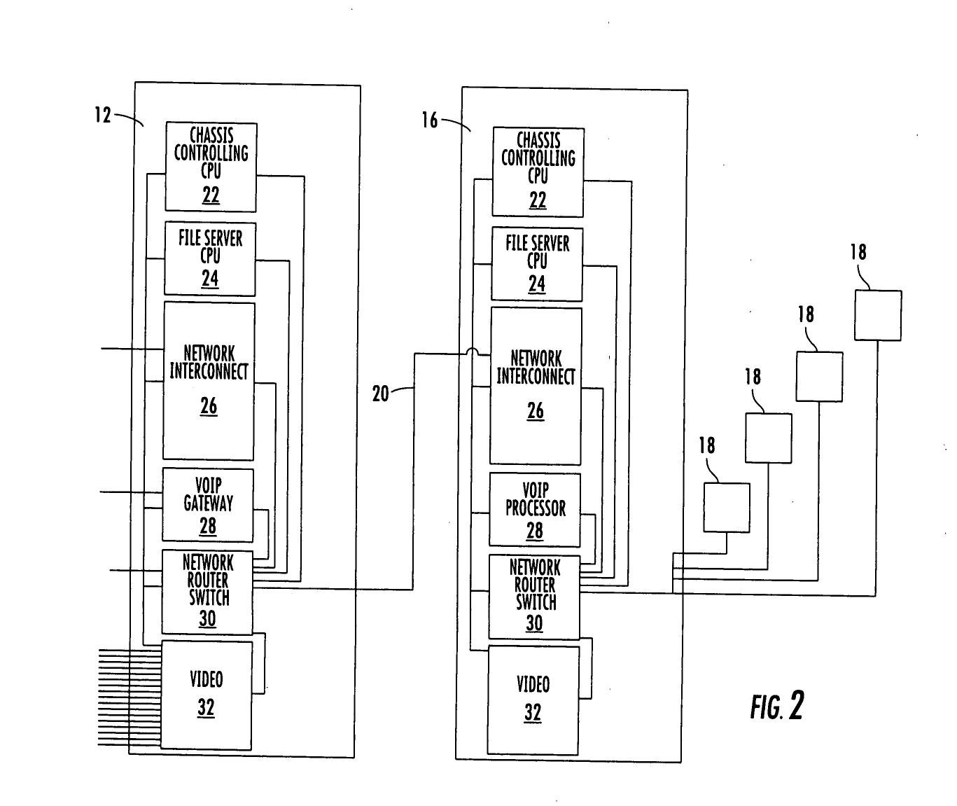

FIG. 2 illustrates the basic functions of the network operating center 12 and the portal 16. The construction and operating principles of the network operation center 12 and the portal 16 are substantially identical. The distinguishing factor between the two devices is their location and function. For example, the same chassis may be located at a central monitoring office, or at a remote site, and reconfigured as needed. Each unit is constructed with a modular chassis and includes a controlling CPU 22, a file server 24, a network interconnect 26, a VoIP processor or gateway 28, a network router switch 30, and a video processing module 32. The network operating center 12 receives a number of different types of multimedia content which may be digital or analog. It then coverts this content to packetized information and transmits it over the data line 20 to the portal 16. The portal 16 routes the incoming packets to the proper internal processing module, where they are reconverted to the appropriate format as needed (for example, MPEG video data may be converted to PAL or NTSC video output). The information is then sent out to the end user units (depicted generally at 18.)

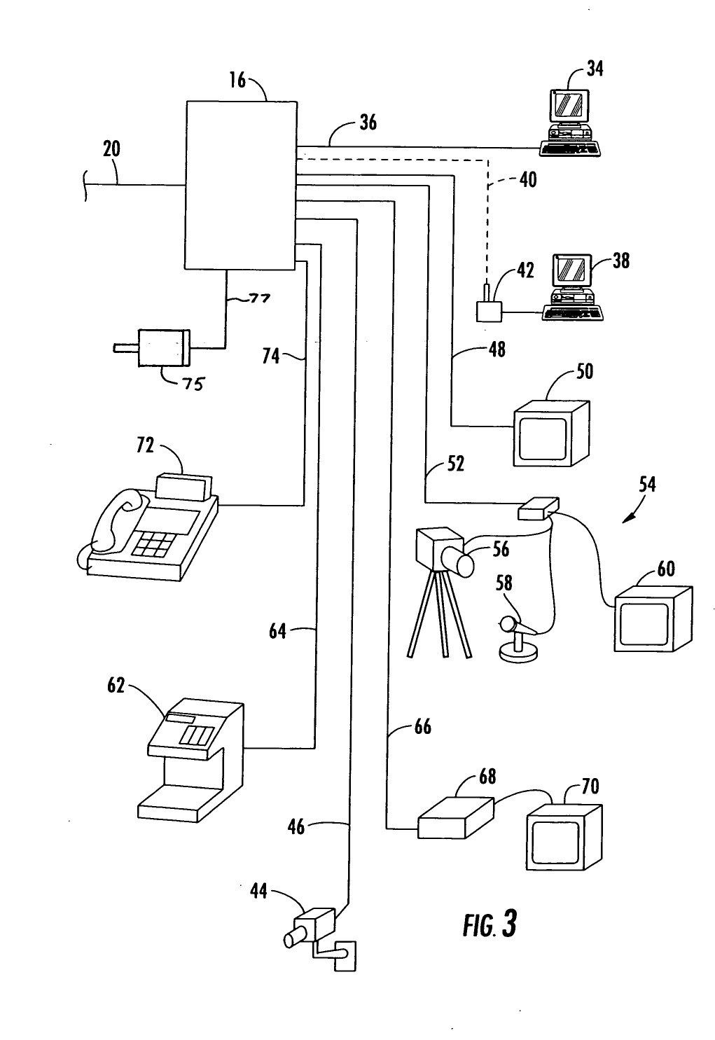

FIG. 3 illustrates the layout of a remote client network 14. As noted above, the remote client network 14 includes a portal 16, and one or more end user units. The end user units can include any type of information exchange technology, whether it be analog or digital. FIG. 3 shows examples of several different types of end user units. A first computer workstation 34 is connected to the portal 16 over a hardwired local area network 36. The first workstation 34 sends and receive data packets to and from the portal 16. A second computer workstation 38 is connected to the portal 16 over a wireless signal path 40 using a transceiver 42. The second workstation 38 sends and receives data packets to and from the portal 16. A security camera 44 transmits analog or digital video signals over a line 46 to the portal 16. Analog video signals (such as PAL or NTSC) are transmitted over lines 48 from the portal 16 to a television monitor 50. Audio and video is transmitted bidirectionally over a line 52 between the portal 16 and videoconferencing equipment 54 which includes a camera 56, a microphone 58, and a monitor 60. A security device 62, such as a palm reader, transmits data to and from the portal 16 over a data line 64. Video on demand signals are sent from the portal 16 over a line 66 to a set-top-box 68 connected to a television monitor 70. Telephone equipment 72 is connected to the portal 16 by a data line 74. Finally, a process device 75 such as the illustrated electric motor, a valve actuator, thermostat, pressure sensor or other related portion of an industrial process may be connected to the portal 16 by a data line 77. Sensor and control data may be transmitted to and from the portal 16, which can analyze and report the data as well as sending control signals to the process 77.

The information streams for all of the end user functions described above are routed through the portal 16. The portal 16 thus replaces a number of other types of telecommunications hardware. The portal 16, which is described in detail below, is modular in design and may be easily reconfigured to perform the needed combination of telecommunications functions.

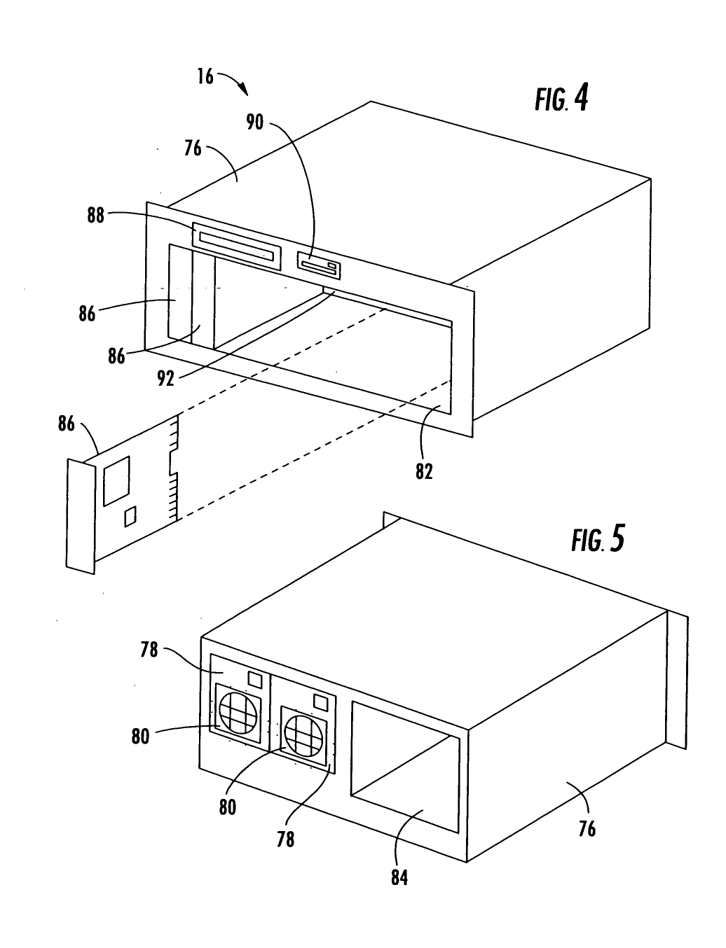

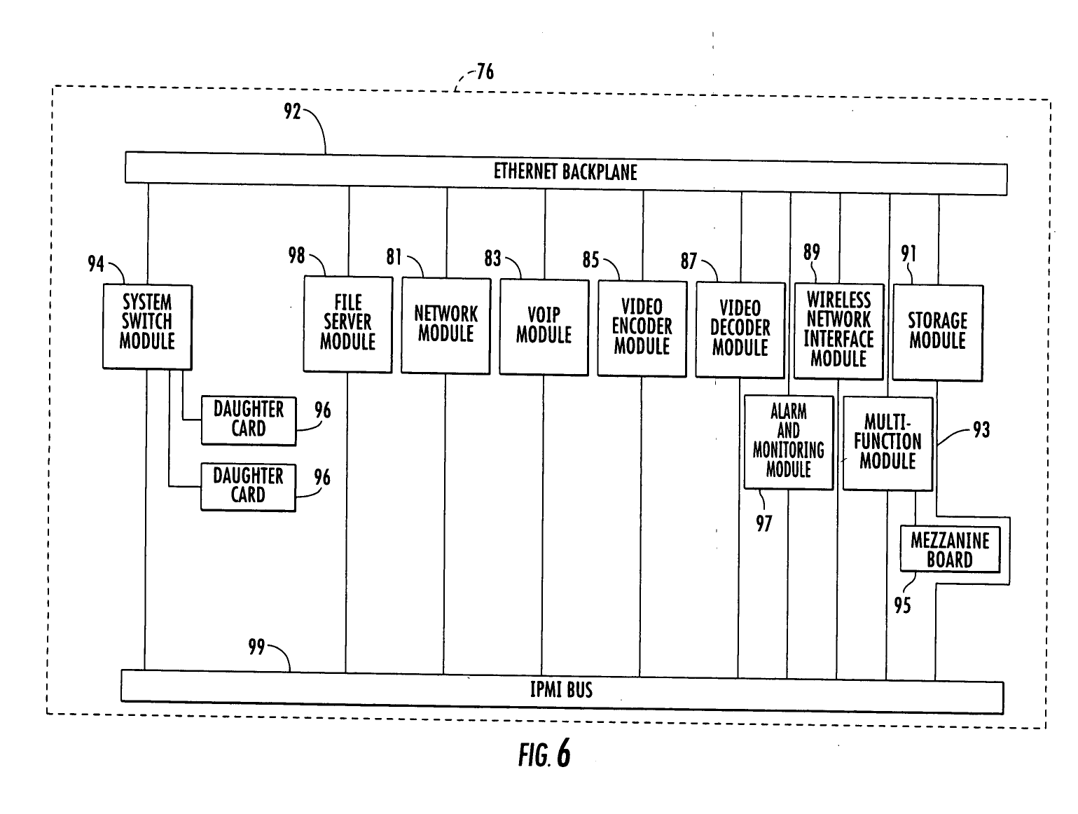

FIGS. 4 and 5 illustrate the physical construction of the portal 16. As noted above, the network operating center 12 is substantially identical in construction to the portal 16, and thus the following description applies to both units. The portal 16 comprises a rack-mountable chassis 76 of a known type. The chassis 76 includes one or more power supplies 78 which receive line power, condition it as necessary, and supply it to the individual modules. The chassis 76 can support several redundant load sharing hot-swappable power supplies, and includes redundant hot-swappable cooling fans 80. Any one of the power supplies 78 or the cooling fans 80 can be removed and replaced without interrupting the operation of the portal 16. The chassis 76 includes a front card bay 82 and a rear card bay 84, which receive individual modules 86 (described below), mounted on removable cards having a standard form factor. The illustrated example is sized for standard 6U width cards. The number of card slots and the chassis width may be varied to suit a particular application. The chassis 76 may also include additional input/output (I/O) devices such as an optical drive 88 (e.g., CD-ROM or DVD) and a magnetic data drive 90 (e.g. 3.5″ floppy disk drive). These input/output devices may be used for storage or for software updating purposes. The chassis 76 includes a packet switching backplane 92, to which the individual modules 86 are connected.

The backplane 92 is preferably Gigabit Ethernet (1000 BaseT). The backplane 92 provides a packet-switched network, wherein each of the connected modules acts as a individual node on a network, in contrast to an ordinary hardware bus. This architecture provides redundancy and upgradeability. Any of the individual modules may be replaced in case of failure or when more advanced capabilities are available. Furthermore, the entire system will not be disabled by a single faulted module. Examples of known suitable Ethernet backplane standards include PCI Industrial Computers Manufacturers Group (PICMG) standards 2.16, 2.19, 2.20, 2.10 R3.0, and Compact PCI (cPCI).

Referring now to FIG. 6, a system switch module 94, is installed in the chassis 76 and connected to the backplane 92. The switch module 94 serves to control and coordinate the functions of the other modules in the chassis 76 (which are generally referred to herein as application modules) and is responsible for all Ethernet connections into and out of the portal 16. The switch module 94 is a single board computer, or in other words a complete computer contained on a single 6U card. Because of the modular construction, the switch module 94 can be easily upgraded as improved hardware becomes available, or replaced if faulty. The specifications of the switch module 94 may be varied to suit a particular application. In the illustrated example, the switch module 94 includes a PENTIUM-class or PowerPC central processor of 500 MHz to 2.4 GHz clock speed, 256 Mb to 4 Gb of random access memory (RAM), a flash memory card, a 40 Gb hard drive, and an Ethernet to Gigabit network interface. The switch module 94 may include slots for known types of daughter cards 96, capable of supporting functions such as Ethernet optics (short & long haul), asynchronous transfer mode communications (ATM), wide area networking (WAN), and wireless networking (for example WIFI or 802.11a/b/g). The switch module 94 supports multiple Ethernet connections, for example 24 separate connections, via the backplane 92 or an integral rear interface module.

A configuration program running on the switch module 94 serves as the central control to the portal 16, and all of the modules in the portal 16 are configured via the switch module 94. The following processes will run on the switch module 94: packet forwarding to and from the individual modules in the portal 16, packet routing protocols, filtering, high availability networking (switch redundancy), domain name server (DNS), dynamic host configuration protocol server & client (DHCP), network time protocol client (NTP), simple network management protocol agent (SNMP), statefull firewall, and web server (HTTP) for configuration and management of the portal 16. This gives the end user a single point of contact for all application modules in the portal 16. The configuration program also receives intelligent platform management interface (IPMI) information via an alarm and monitoring module 97 (described below). The configuration program may be based on the LINUX operating system and may include C and C++ on WINDOWS, and/or THREADX OS.

As noted above, each of the application modules (described below) operate independently of one another. If there is inter-module communication, it is accomplished through the Ethernet connections to the switch module 94. Each application module in the portal 16 is dependent on the switch module 94 for outside communication.

A file server module 98 may be installed in the chassis 76 and connected to the backplane 92. The file server module 98 is a single board computer, which may be similar in architecture to the switch module 94. The file server module 98 performs the same functions of a stand-alone filer server unit, such as storage and retrieval of data files. Its exact architecture and specifications will depend upon the particular end user's needs.

A network module 81 may be installed in the chassis 76 and connected to the backplane 92. The network module 81 may be a known type of switch or router working on TCP/IP layer 2, 3, or 4 switching as required.

A voice over Internet protocol (VoIP) module 83 may be installed in the chassis 76 and connected to the backplane 92. The function of the VoIP module 83 is to route voice data between the portal 16 and a telephone network. Examples of known types of VoIP modules include soft switches, private branch exchange (PBX) interfaces, Class 5 switch interfaces, DS3 output, or DS1 output.

A video encoder module 85 of a known type may be installed in the chassis 76 and connected to the backplane 92. The video encoder module 85 receives video signals from end user units (for example, surveillance cameras) in a variety of formats and converts them into data packets which can then be routed over the backplane 92. Exemplary input formats include PAL and NTSC. Exemplary output formats include baseband video, S-video, composite video, broadcast television systems committee (BTSC) stereo, balanced audio, secondary audio program (SAP) audio, closed caption, motion picture experts group (MPEG) 2, 3, or 4, quality of service (QOS) encapsulated, IP encapsulated, Ethernet encapsulated, streaming video, video server, video on demand, video conferencing, video telephone, HD security, surveillance.

A video decoder module 87 of a known type may be installed in the chassis 76 and connected to the backplane 92. The video decoder module 87 receives data packets routed over the backplane 92 and convert them into video signals in a variety of formats, which can then be transferred over lines to end user units (for example, television monitors). Examples of video input formats include Ethernet streaming video, MPEG 2, 3, or 4. Examples of video output formats include baseband video, S-video, composite video, BTSC stereo, balanced audio, SAP audio, closed caption, MPEG 2, 3, or 4, video on demand, video conferencing, video telephone, HD security video, surveillance video, PAL, and NTSC.

A wireless network interface module 89 of a known type may be installed in the chassis 76 and connected to the backplane 92. The wireless network interface module 89 transfers data to and from the backplane 92 to user units (such as wireless transceivers). Examples of suitable wireless network protocols include Ethernet IP, 802.11b, and 802.11g.

A storage module 91 may be installed in the chassis 76 and connected to the backplane 92. The storage module 91 includes multiple hard drives or other types of data storage, and may be used for video storage, data file storage, or database storage.

A multi-function module 93 may be installed in the chassis 76 and connected to the backplane 92. It can be used as a central point for the connection of PCI mezzanine cards (PMC), PTMC cards, or PCI boards for functions such as wireless network interfacing, shown in FIG. 6 at 95.

An alarm and monitoring module 97 is installed in the chassis 76 and connected to the switch module 94 through the backplane 92. The alarm and monitoring module 97 has its own unique slot in the chassis 76. The alarm and monitoring module 97 will not fit in any other slot, and no other module will fit in the slot dedicated to the alarm and monitoring module 97. As shown in FIG. 6, the alarm and monitoring module 97 has connections to all the modules in the chassis 76 via an IPMI management bus 99. The alarm and monitoring module 97 will also have an Ethernet connection to the backplane 92. The alarm and monitoring module 97 runs embedded LINUX-based software that works in concert with the switch module 94 to provide intelligent product management interface (IPMI) baseboard management controller (BMC) information, which it obtains by polling all of the individual modules in the chassis 76, in conformance with IPMI specification 1.5. This information includes data about the chassis 76 and individual modules, such as power consumption, board temperature, and cooling fan speed.

A portal executive enables the operation of the portal 16. The portal executive may be embodied in various physical forms. For example, the portal executive could be implemented in the configuration program running on the switch module 94. Alternatively, the portal executive could be implemented within the embedded software running on the alarm and monitoring module 97, which in turn would issue commands to the switch module 94. In any event, all of the modular slots in the chassis 76 are continuously monitored via the backplane 92. This monitoring function includes the chassis 76, application modules, fans 80, power supplies 78, and other operating components. The portal executive determines the presence, slot location, type, specific model number, operational status, and global unique identifier number (GUID) of each module. At least one operational parameter of each module is monitored by sensor data from one or more sensors of a known type (not shown). Examples of such operational parameters include board temperatures, cooling fan RPM, power consumption, and chassis position. The portal executive can detect hundreds of parameters within seconds. The portal executive is designed not only to monitor devices, but to set specific parameters on each individual device to pro-actively monitor when the module is registering specific levels of performance relative to a baseline value. The degree of deviation from baseline performance may be divided into categories such as minor performance, major performance, critical performance, and non-functional performance. These categories are predetermined based on criteria such as empirical operating experience or theoretical models of a component's performance.

Baseline categorical values for each operational parameter are provided to the control software. As a specific example which is representative of the other operational parameters, one of the cooling fans 80 may operate at a certain rated speed or a relatively narrow rated range of speeds in normal operation. This speed or speed range is stored as a baseline data value accessible to the portal executive. If the cooling fan 80 begins to fail, the fan speed may decrease before it completely stops. At some degree of speed reduction, the cooling fan 80 may provide degraded performance, e.g. insufficient airflow volume or velocity, even though it has not completely failed. The degree of deviation is categorized as minor performance, major performance, critical performance, and non-functional performance, or similar categories, as noted above. The more severe the degradation, the more likely an imminent failure will occur and/or the less time available to take corrective action without interrupting the operation of the portal 16.

Whenever the sensor data deviates from the baseline values, the portal executive performs a control action. Generally stated, a control action is an action having the purpose of ensuring continued operation of the portal 16. For example, the portal executive can provide to a user or administrator status information through the GUI (described below), or it can send such information to a designated email address or pager number. Visual and/or audible alarm alerts such as warning lights or warning tones may also be provided. The portal executive is designed for remote accessibility so it can start and restart the system from a local and/or remote location.

For example, if a module is starting to fail based on the comparison of the sensor data to the baseline values, the portal executive may activate a backup module, switch system workload to a redundant module, shut down the failing module, and send an email alert to maintenance personnel that the module requires replacement. The defective module may then be replaced without interruption to the portal 16. The control actions may be staged depending upon the deviation category. For example, if a minor performance condition occurs, then an email message may be sent to an operator indicating that maintenance is required sometime in the future. However, if a critical performance condition occurs, an immediate pager alert may be transmitted. Thus, the portal executive is able to maintain continuous operation of the portal 16.

A software utility management tool may be provided to retrieve information about the modules and chassis 76 from the alarm and monitor module via an Ethernet connection to the portal 16. This information can be retrieved by request from the end user.

An example of the operation of the telecommunications system 10 is as follows: an end user at a workstation 34 (see FIG. 3) sends a network request for a data file. The file request is routed over the LAN 36 to the portal 16, arriving through the network module 81 (see FIG. 6). Internally, the switch module 94 receives the file request from the network module 81 and sends it to the file server module 98 over the backplane 92. The file server module 98 then accesses the required file content. Depending on the construction chosen, the file server module 98 may retrieve the file from its internal storage, or from a storage module 91 over the backplane 92. The requested file is then routed back out through the switch module 94, the network module 81, and the LAN 36 to the workstation 34.

Simultaneously, a security camera 44 (see FIG. 3) may be sending an analog video signal (for example PAL or NTSC) to the portal 16 over a line 46. This video signal is received by the video encoder module 85 (see FIG. 6) where it is converted to a stream of packetized data. This data is then routed to the switch module 94. The video packets are transmitted to various destinations depending on the user's preference. For example, the video packets may be transmitted over an external network to the network operating center 12 (see FIG. 1) at a central monitoring station. Alternatively, the packets could be routed over the backplane 92 to a storage module 91 for later review.

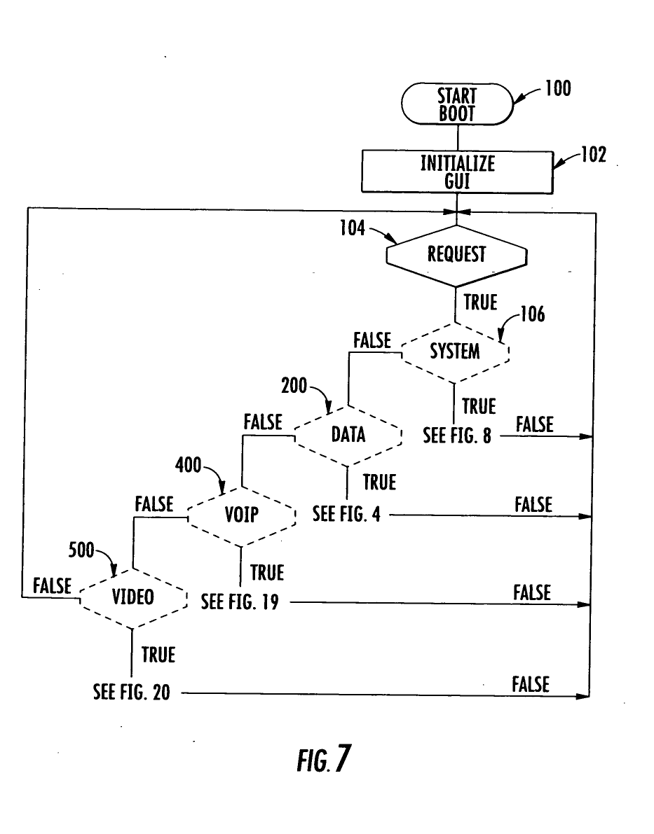

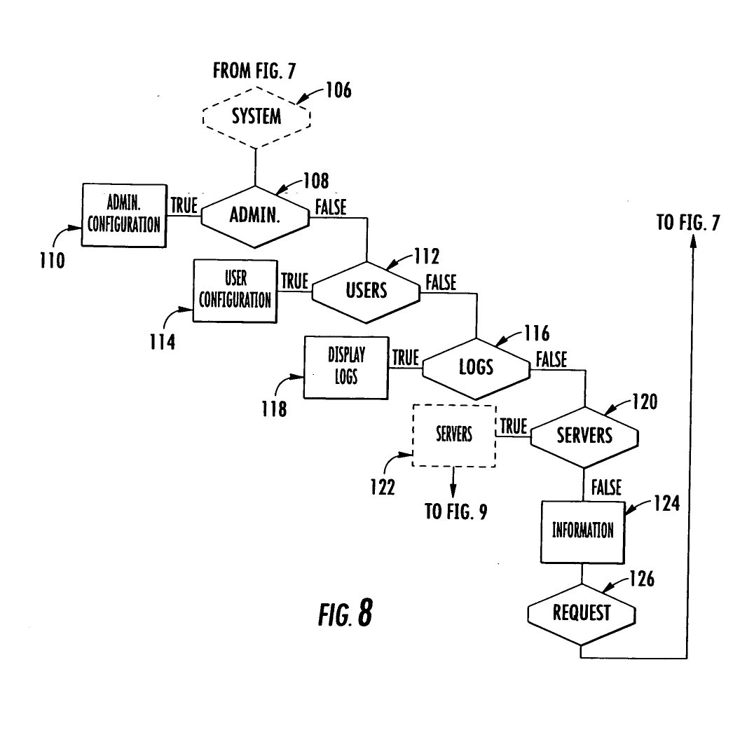

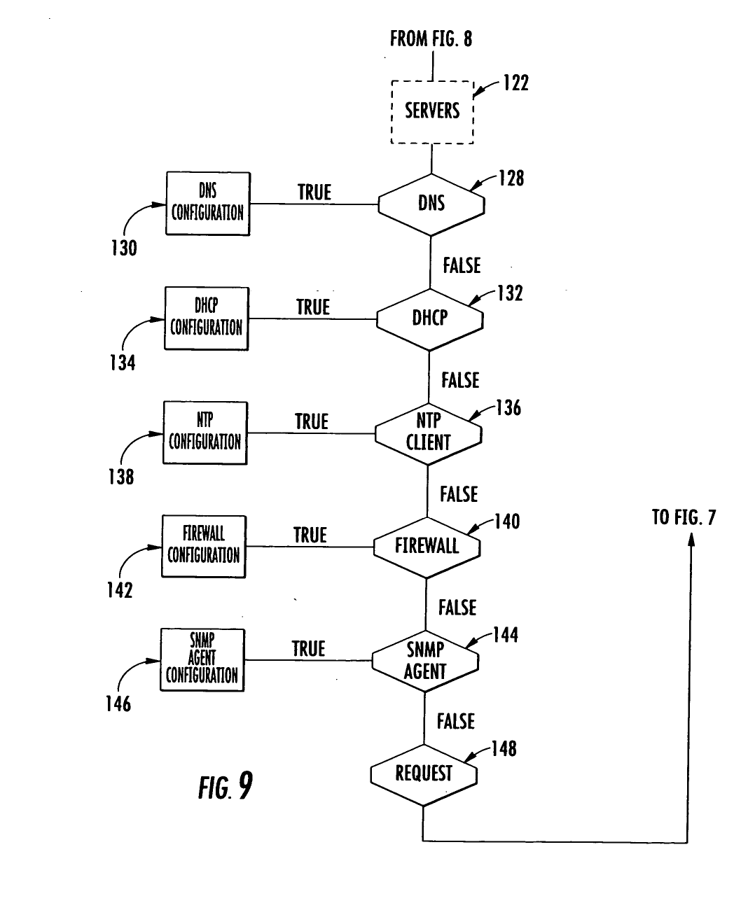

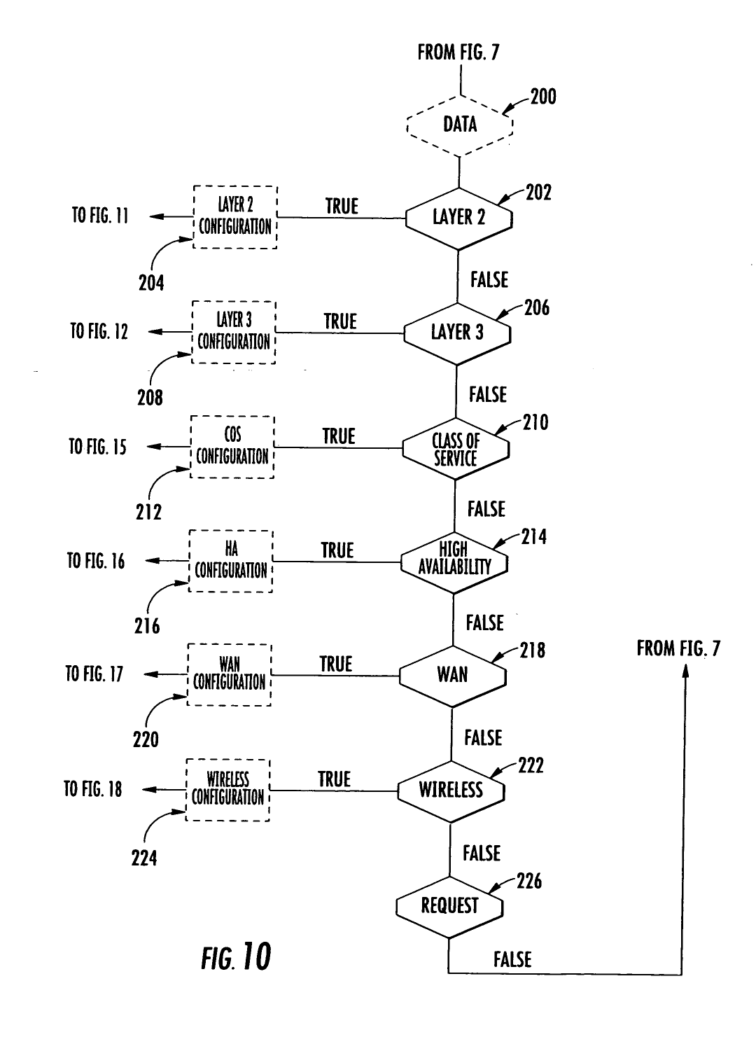

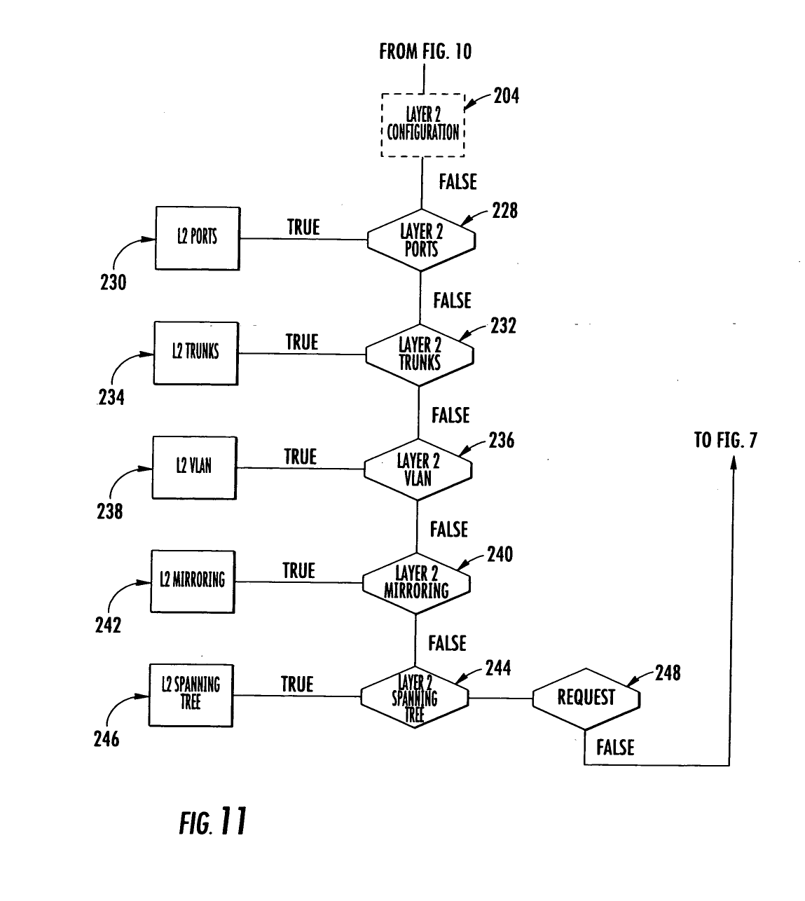

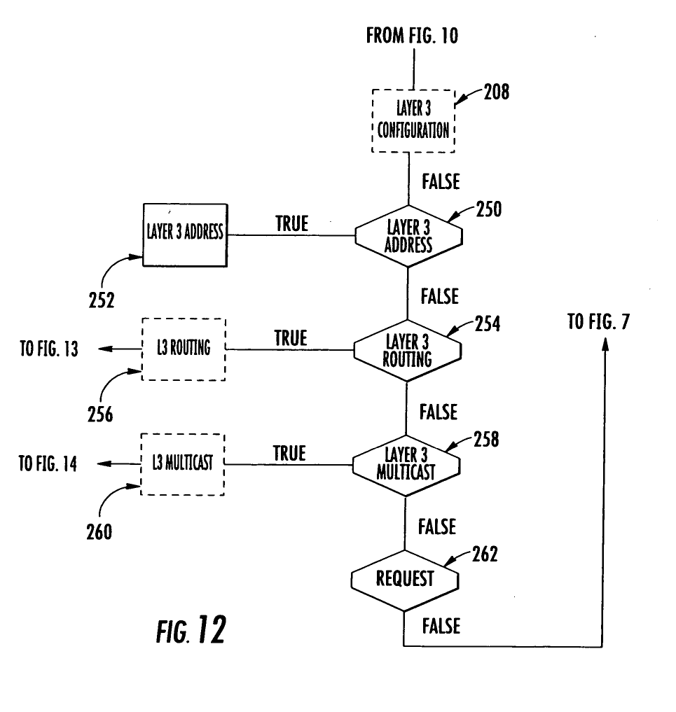

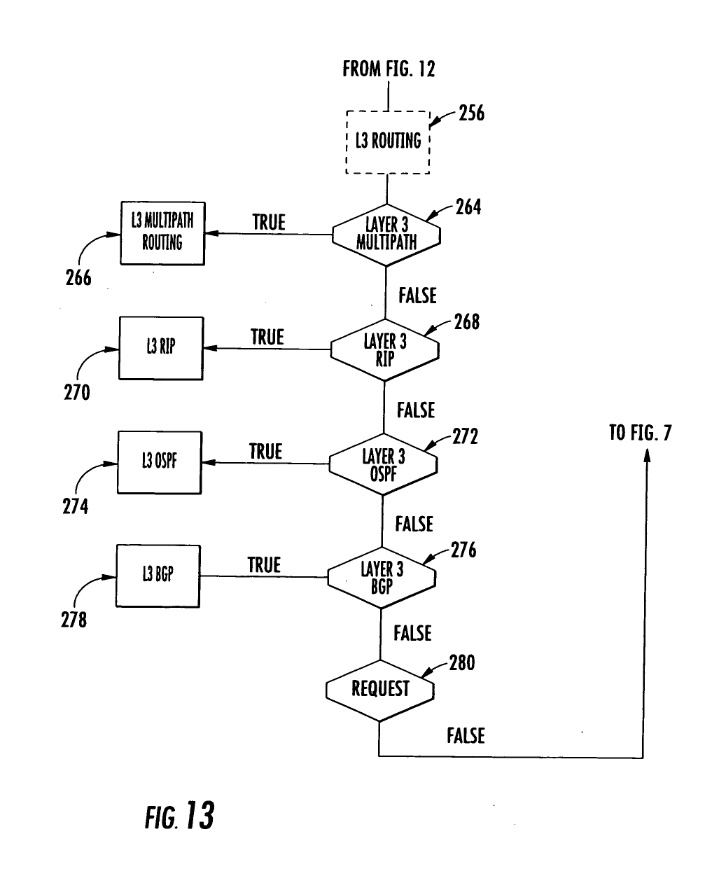

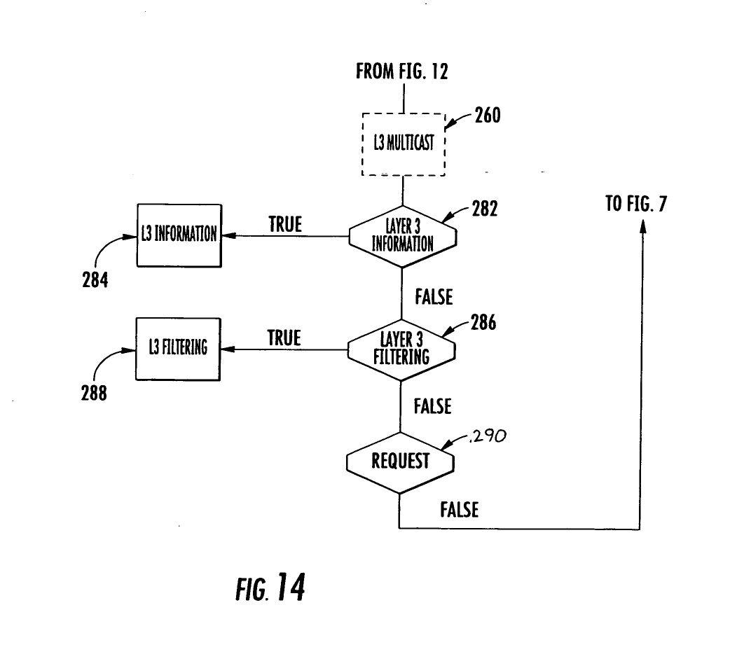

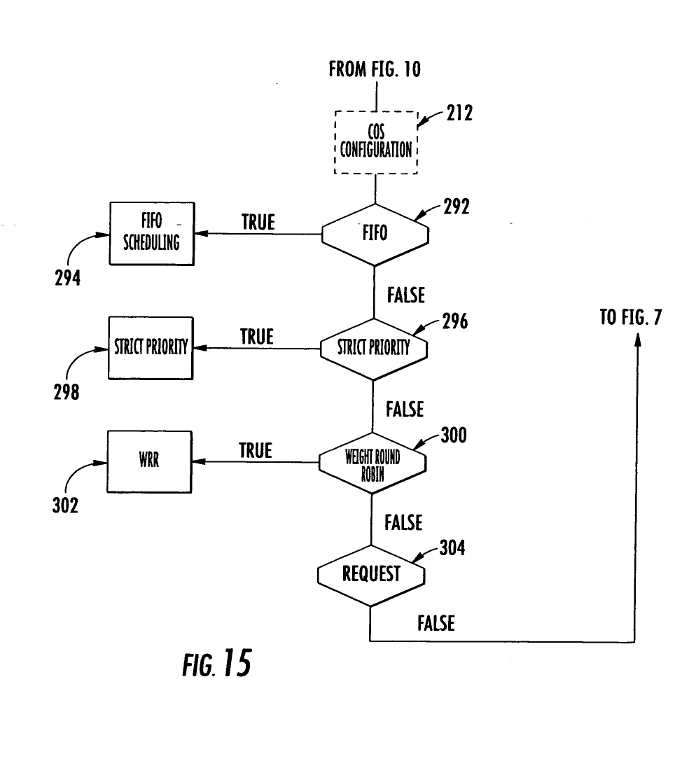

An example of the operation of the configuration program running on the switch module 94 will now be described with reference to FIGS. 7-20. It is noted that the term “RFC” used below refers to specified Requests For Comments, which are published documents used by the Internet Engineering Task Force (IETF) describing the specifications for a recommended technology. FIG. 7 is a flow diagram of a software-implemented initialization and recovery procedure for the switch module 94 of the portal 16. The control software may take any known form, but is preferably implemented with an interface that may be accessed using a standard web browser, such as Microsoft Internet Explorer or Netscape Navigator. The initialization begins with a start step 100. The user points their web browser to a visual depiction of the control module 16 and a logon prompt will be displayed. Once the user is authenticated a graphical user interface (GUI) home page 102 will be displayed. The home page 102 will show a graphical picture of the chassis 76 and all modules that are installed in the chassis 76. The user will be able make a request at block 104, to select any modules and the program will initiate the appropriate configuration section. In a keep-alive standby request decisional mode step 104, if the user selects the system type a new menu is displayed. The system 106 is the default or system home page. This information is obtained from the Alarm and monitoring module 97. In FIG. 8, at the administration level 108, this allows the user to set the system settings 110, including the system name, domain name, contact name, date, time, system location, and system contact. Once a change is made and applied (for example by clicking an “apply” button in the software interface), the program will write the changes to the necessary locations on the system. At the users level 112, the user configuration 114 initiates the system users and passwords which can be added or deleted in the system. At the logs level 116 is the logs display 118, where all of the various system logs can be viewed. At the servers level 120, access to the server configuration 122 is where a list of available servers or services can be selected for configuration. If no selections are executed the information level 124 displays the switch information home page for system default or back to request 126, and returns to block 104 (see FIG. 7).

FIG. 9 depicts the servers 122 information flow, continued from FIG. 7. A selection from the servers 122 is where the system wide server configuration is done. When a selection of the domain name server (DNS) level 128 accesses the DNS configuration 130, a selection of internet domain name server can be completed. At the dynamic host configuration protocol (DHCP) level 132, access to the DHCP configuration 134, a selection of DHCP server, DHCP client, and/or DHCP relay can be made. The firewall level 140 accesses the firewall installer 142, which lets the user upload the firewall configuration script for Network Address Translation-NAT (RFC1631), which is implemented on CPU NTP Client (RFC 1305) and/or Packet filtering (stateless or statefull)—firewall simple network management protocol (SNMP). In accessing the SNMP agent 144, the user can Choose SNMP agent configuration 146, simple network management protocol, to configure either; SNMP V1 (RFC 1157), SNMP V2 (RFC 1907), SNMP V3 (RFC 2271), MIB II (RFC 1213), MIB II Interface updates (RFC 2863), Defining Traps for SNMP (RFC2863), RIPv2 MIB (RFC 1724), OSPFv2 MIB (RFC 1850), BGPv3 MIB (RFC 1269), SMUX MIB (RFC 1227), VLAN Extensions MIB (RFC 2674), Bridge MIB (RFC 1493), VRRP MIB (RFC 2787), Remote Network Monitoring MIB (RFC 2819), IPv4 Multicast Routing MIB (RFC 2932), IP Forwarding Table MIB (RFC 2096), Textual Conventions for SMIv2 (RFC 2579), Ethernet-Like MIB (RFC 2665), and/or Differentiated Service MIB (IETF Draft). If no selections are executed the display shows the switch information home page for system default or back to request 148, and returns to block 104 at FIG. 7.

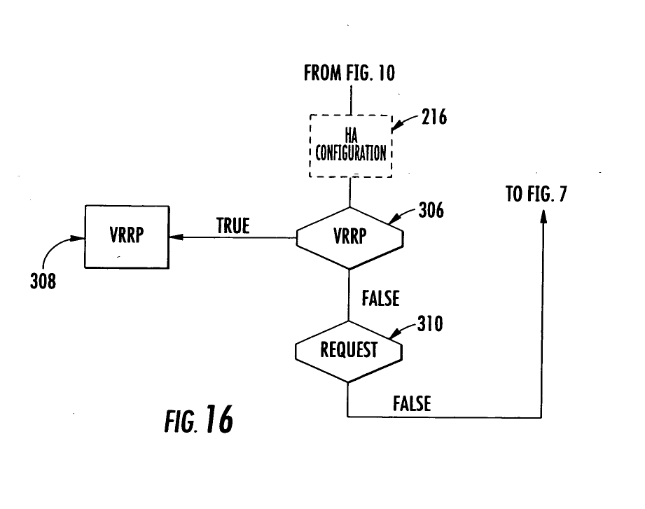

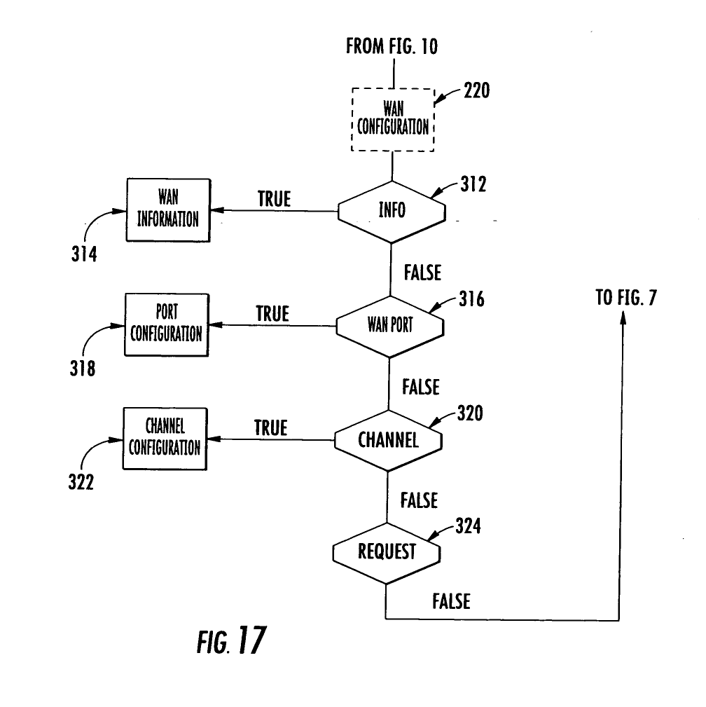

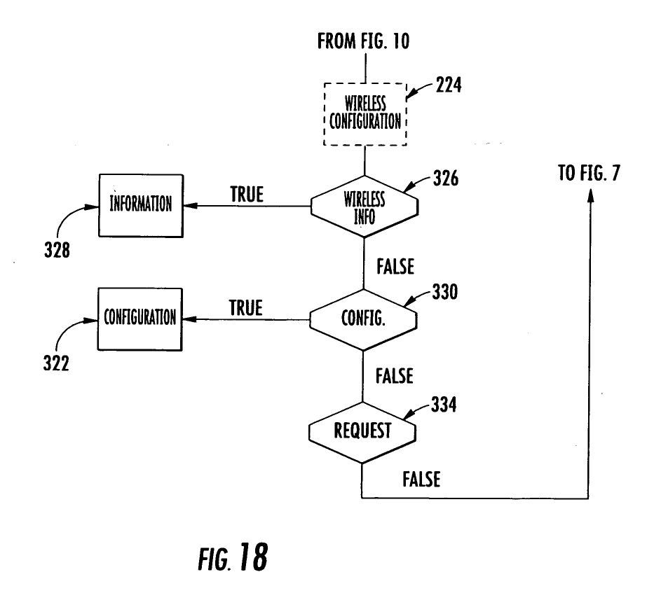

FIG. 10 depicts is the data flow from block 200 of FIG. 7. This again is the default or system home page. This will show a graphical picture of the data portions in the chassis 76. The user will be able to select the modules and the program and will direct them to the appropriate configuration section. The information is obtained from the alarm and monitoring module 97. If layer 2, 202 is selected it will direct user to Layer 2 configuration 204 which allows the user to set Layer 2 (open system interconnection or OSI model) configuration settings. As shown in FIG. 11, the layer 2 ports 228, direct the user to L2 ports 230 to set individual port settings. These settings include: administration state of the port, duplex (half or full), and speed (10 or 100). If layer 2 trunks 232 is selected it will move the user to L2 trunks 234, which allow the user to create, modify, and delete port trunking or bonding. If layer 2 VLAN 236 is selected it directs the user to L2 VLAN 238, and will allow the user to create, modify, and delete a virtual LAN in the chassis. If layer 2 mirroring 240 is selected it will direct the user to L2 mirroring 242, and will allow the user to define port mirroring. This is used for a network monitoring device. If layer 2 spanning tree 244 is selected it will direct the user to L2 spanning tree 246, which is where the user can configure IEEE 802.1d spanning tree. Once a change is made and applied, the program will write the changes to the switch chip in the system. If no selections are executed the display shows the switch information home page for system default or back to request 248, and returns to block 104 (see FIG. 7).

Referring again to FIG. 10, if the selection is layer 3 at 206, it will direct the user to layer 3 configuration 208. As seen in FIG. 12, the user is allowed to set layer 3 (OSI Model) configuration settings, IP address, subnet mask, and default gateway information. If layer 3 address 250 is selected the user is directed to L3 address 252. At layer 3 routing 254 the user is directed to L3 routing 256. Referring to FIG. 13, the user is allowed from block 256 to set Layer 3 (OSI Model) configuration and routing information. At layer 3 multipath 264 the user is directed to L3 multipath routing 266 static routes. At layer 3 routing information protocol (RIP) 268 the user is directed to L3 routing information protocol in block 270 which may include version 1 & 2 (RIP), RIPv1 (RFC 1058), or RIPv2 (RFC 1723). At Layer 3 OSPF 272 the user is directed to L3 open shortest path first (OSPF) 274. Suitable standards for OSPF include OSPFv1 (RFC 1850), OSPFv2 (RFC 2328), OSPF NSSA (RFC 1587), and OSPF-BGP Interaction—(RFC 1745). At Layer 3 border gateway protocol (BGP) 276 the user is directed to L3 BGP 278, such as EGP (RFC 904), BGP-3 (RFC 1267), default route advertisement (RFC 1397), BGP route reflection (RFC 1966), or BGP-OSPF interaction (RFC 1745). If no selections are executed the display shows the switch information home page for system default or back to request 280, and returns to block 104 at FIG. 7.

As seen in FIG. 12, the user at Layer 3 multicast 258 is directed to L3 multicast 260. Here the user is allowed to configure multicast settings. Referring to FIG. 14, from block 260 if the user selects Layer 3 information 282 the user is directed to L3 information 284 where the multicast settings are listed. At Layer 3 filtering 286, the user can configure filtering, IGMP Snooping, IGMPv2 (RFC 2236), and DVMRPv3 (IETF Draft). If no selections are executed the display shows the switch information home page for system default or back to request 290, and returns to block 104 at FIG. 7.

At FIG. 10 selecting class of service 210 directs the user to COS configuration, which is depicted in FIG. 15. At 212 the user can prioritize traffic through the switch module 94 . The chassis 76 will support 1, 2, or 4 queues per egress port. Packets are assigned to queues to their IEEE 802.1p tags, TOS—Types of Service (RFC 1349), Architecture for Differentiated Services (RFC 2475), and DS Field (RFC 2475). At 292 FIFO directs the user to First In-First Out Scheduling 294. Here traffic is serviced in the order in which it arrives. At strict priority 296 the user is directed to strict priority 298 where the highest priority queue is always serviced first. As long as there is traffic in the high priority queue, the lower priority queues are not services. At weight round robin 300 the user is directed to WRR Schedule 302 where each queue is assigned a weight. Each queue will be serviced based on its weight. If no selections are executed the display shows the switch information home page for system default or back to request 304, and returns to block 104 at FIG. 7.

At FIG. 10 high availability 214 directs user to HA configuration 216. Referring to FIG. 16, at HA Configuration 216 the user selects Virtual Router Redundancy Protocol (VRRP) 306 which directs the user to VRRP Configuration 308. This allows the user to configure VRRP (for example VRRP RFC 2338). This protocol will provide transparent failover of the default router address to another switch in the chassis 76 or network. If no selections are executed the display shows the switch information home page for system default or back to request 310, and returns to block 104 at FIG. 7.

Referring again to FIG. 10, selecting wide area network (WAN) 218 directs the user to WAN configuration 220 where the user will configure all WAN modules in the chassis. As shown in FIG. 17, at WAN information 312 the user is directed to WAN information 314. The WAN information screen will display all the configured WAN interfaces in the system. This will include information by port and channel, for example: port number, port framing, port line build out, channel number, channel timeslots, channel framing, and channel protocol. At WAN port 316 the user is directed to port configuration 318 where the user configures T1/E1 including port settings, (T1_SF) for T1 Superframe/D4 (B8ZS), (T1_ESF) for T1 Extended Superframe (B8ZS), (T1_SF_AMI) for T1 Superframe (AMI), (T1_ESF_AMI) for T1 Extended Superframe (AMI), (E1_CRC) for E1 in CRC Multiframe Format (HDB3), (E1_CRCCAS) for E1 in CRC Multiframe Format with CAS (HDB3), (E1_CRC_AMI) for E1 in CRC Multiframe Format (AMI), and (E1_CRCCAS_AMI) for E1 in CRC Multiframe Format with CAS (AMI). The user configures Line Build Out (T1 Only), (T1 “Long Haul” in db): LHO=0 db, LH7_{—}5=7.5 db, LH15=15 db, LH22_{—}5=22.5 db. (T1 “Short Haul” in feet ): SH110=110 ft., SH220=220 ft., SH330=330 ft., SH440=440 ft., SH550=550 ft., SH660=660 ft. E1 requires only one fixed setting, E75=75 ohm interface (BNC connectors), E120=120 ohm interface (RJ48 Twisted Pair). Loopback Mode; off=Normal operation (default), Loopback disabled, payid=Payload Loopback. Frames received from the remote device are passed through the T1/E1 receive framer, looped back to the transmit side, reframed and returned to the remote device, line=Line Loopback. Frames received from the remote device are returned to the transmit side with the original framing intact, ddigi=Diagnostic digital loopback. Frames from the host passed through the transmit framer, looped back into the receive framer and returned to the host. At channel 320 the user is directed to channel configuration 322. These commands create, configure, and delete channels consisting of one or more DSOs; HDLC Channel enable/disable; OFF=Channel disable, RX=Enabled for receive only (transmitter disabled), TX=Enabled for transmit only (receiver disabled), RXTX=Enabled for transmit and receive. HDLC FCS mode; selects between 16 or 32 bit Frame Check Sum (FCS), or ISLP; HDLC_FCS16=16 bit HDLC FCS, HDLC_FCS32=32 bit HDLC FCS, ISLP=Intersystem Link Protocol, No FCS calculated on transmit, any received FCS is passed up along with message, TRANS=Transparent mode; on transmit no HDLC framing is performed; on receive, a bit stream is accepted with no ISO layer 2 framing recognized. If no selections are executed the display shows the switch information home page for system default or back to request 324, and returns to block 104 at FIG. 7.

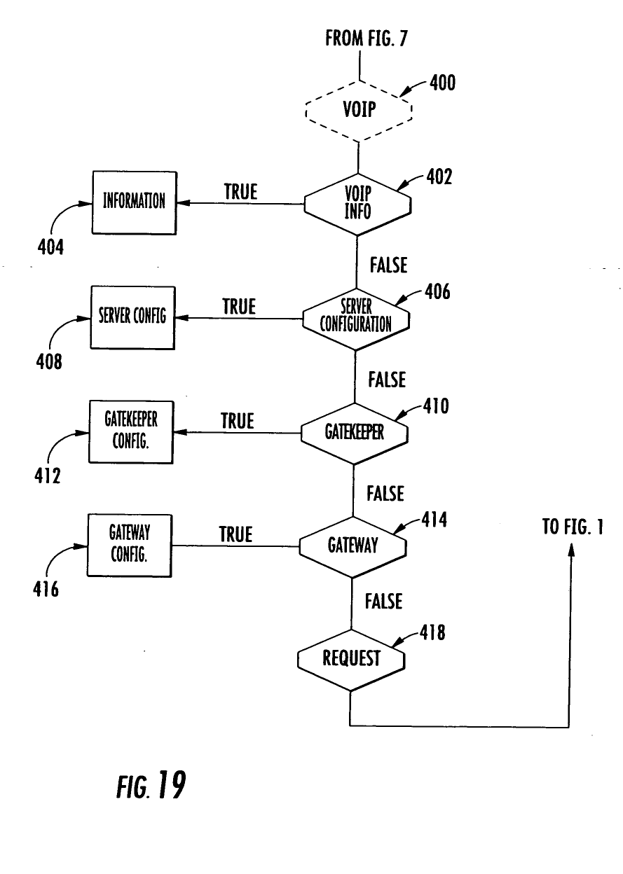

Referring again to FIG. 10, selecting wireless 224 directs the user to wireless information 326 (see FIG. 18). The user can select information 328 which will display all wireless configurations. At configuration 330 the user is directed to wireless configuration 332. The configuration will allow the user to select several wireless adapters. The chassis can support the multiple wireless standards including the following examples: IEEE 802.1a, IEEE 802.1b, and 802.1g. If no selections are executed the display shows the switch information home page for system default or back to request 334, and returns to block 104 at FIG. 7.

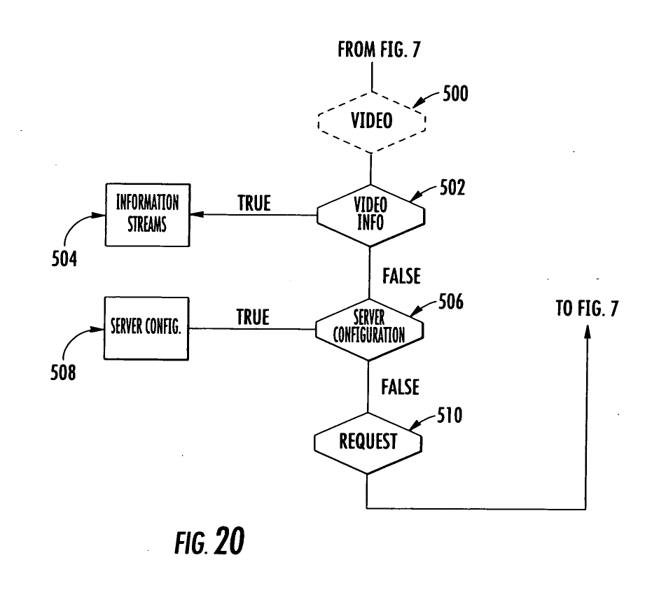

Referring again to FIG. 7, the user may select VoIP 400 (see FIG. 19). This moves to user to VoIP information 402 which directs the user to information 404. This displays the information settings for the VoIP module 83 (see FIG. 6). At ILS server configuration 406 the user is allowed to configure the server at 408. Internet Locator Server (ILS) is a server which allows the user to solve a name during an H323 standard calling. When a VoIP application is started the user first registers to the ILS server a name, then everyone will be able to see the user using that name (if all users are using same server ILS). At gatekeeper 410 the user is directed to gatekeeper configuration 412 where the user can configure the gatekeeper. The user can test gatekeeper features. Terminal H323 A, Terminal H323 B, and Terminal H323 C, or hosts A, B, and C have gatekeeper setting to point to D. At a start time the host tells D own address and own name (also with aliases) which could be used by a caller to reach it. When a terminal asks D for a host, D answers with right IP address, it could not join hosts that are not reachable each other (at IP level), in other words it could not act as a network address translation (NAT) router. At gateway 414 the user is directed to gateway configuration 416 which allows the user to configure the gateway. The gateway is an entity that-can join VoIP to public switched telephone network (PSTN) lines allowing them to make calls from the Internet to a standard telephone. If no selections are executed the display shows the switch information home page for system default or back to request 418, and returns to block 104 at FIG. 7.

Referring again to FIG. 7, the user may select video 500 (see FIG. 20). If the user selects video 500 the user can then select video information 502. This directs the user to information streams 504. This is where the user can view the configuration display. At 506 server configuration the user is directed to server configuration 508. Here the user is allowed to configure frame rate (Mbps), multicast address, and multicast port. The user can also configure channel server address and port, UDP or RTP (by choice), enable audio (Yes/No), enable video (Yes/No), video encoding (for example MPEG 1, 2, or 4), and audio encoding (MPEG choice). If no selections are executed the display shows the switch information home page for system default or back to request 510, and returns to block 104 at FIG. 7.

The foregoing has described a telecommunications system including a modular, integrated upgradeable portal which performs multiple information exchange functions. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

1. A control system for a telecommunications portal, comprising:
a modular chassis including an Ethernet backplane and a platform management bus;
at least one application module mounted in said chassis and connected to said backplane and said management bus, said application module performing at least one audio, visual, or data function and transmitting or receiving data related to said function over said backplane;
at least one functional module mounted in said chassis which supports the operation of said application module;
at least one sensor operable to detect operational parameters of at least one of said modules and transmit sensor data representative of said operational parameters over said management bus;
a portal executive connected to said backplane and said management bus;
wherein said portal executive includes means for receiving said sensor data from said management bus, comparing said sensor data to pre-established baseline values for said operational parameters, and performing a control action in response to a deviation of said sensor data from said baseline values.

2. The control system of claim 1 wherein said control action is chosen from the group consisting of: sending an alarm message to a predetermined email address, sending an alert signal to a preselected pager, generating an audible alarm, generating a visual alarm, shutting down an affected module, resetting an affected module, powering-up a backup module, and combinations thereof.

3. The control system of claim 1 wherein said portal executive is operable to selectively power-up or power-down said module.

4. The control system of claim 1 wherein said portal executive is operable to selectively reset said module.

5. The control system of claim 1 wherein said sensor data is categorized into at least two categories depending upon the degree of deviation of said sensor data from said baseline values, and said control action is selected based upon which category said sensor data falls into.

6. The control system of claim 5 wherein said sensor data is characterized into at least minor, major, critical, and non-functional categories, each of said categories representing progressively greater deviation from said baseline values.

7. The control system of claim 1 wherein said module includes a cooling fan driven by an electric motor, and a sensor for detecting the speed of said motor.

8. The control system of claim 1 wherein said application module comprises a plurality of operational components mounted on a circuit board, and said application module includes a sensor which detects the temperature of said circuit board.

9. The control system of claim 1 wherein said application module comprises a plurality of operational components mounted on a circuit board, and said application module includes a sensor which detects the current flow through said circuit board.

10. The control system of claim 1 wherein said chassis includes a plurality of slots for receiving modules, and said slots are continuously polled by said portal executive to determine at least one of:
the presence of a module in a specific slot of said chassis;
the specific model of each module present; and
a unique identification of each module.

11. The control system of claim 1 wherein said portal includes means for updating a software program of at least one of said modules.

12. A method for controlling a telecommunications portal, comprising:
providing a modular chassis including an Ethernet backplane and a platform management bus;
providing a portal executive which is connected to said backplane and said management bus;
providing at least one application module operable to perform at least one audio, visual, or data function, which is mounted in said chassis and connected to said backplane and said management bus;
providing at least one functional module mounted in said chassis which supports the operation of said application module;
detecting operational parameters of at least one of said modules and transmitting sensor data corresponding to said operational parameters through said management bus;
establishing predetermined baseline values for said operational parameters;
receiving said sensor data and comparing said sensor data to said baseline values; and
performing a control action whenever said sensor data deviates from said baseline values.

13. The method of claim 12 wherein said control action is chosen from the group consisting of: sending an alarm message to a predetermined email address, sending an alert signal to a preselected pager, generating an audible alarm, generating a visual alarm, shutting down an affected module, resetting an affected module, powering-up a backup module, and combinations thereof.

14. The method of claim 12 wherein said control action includes selectively powering-up or powering-down said module.

15. The method of claim 12 wherein said portal executive is operable to selectively reset said module.

16. The method of claim 12 wherein said sensor data is categorized into at least two categories depending upon the degree of sensor data deviation from said baseline values; and wherein said control action is selected based upon which category said sensor data falls into.

17. The method of claim 16 wherein said sensor data is characterized into at least minor, major, critical, and non-functional categories, each of said categories representing progressively greater deviation from said baseline values.

18. The method of claim 12 further comprising detecting the speed of a motor which powers a cooling fan.

19. The method of claim 12 wherein the application module comprises a plurality of operational components mounted on a circuit board, and said application module includes a sensor which detects the temperature of said circuit board.

20. The method of claim 12 wherein the application module comprises a plurality of operational components mounted on a circuit board, and said application module includes a sensor which detects the current flow through said circuit board.

21. The method of claim 12 wherein said chassis includes a plurality of slots for receiving modules, and said slots are continuously polled by said portal executive to determine at least one of:
the presence of a module in a specific slot of said chassis;
the specific model of each module present; and
a unique identification of each module.
